(19) United States
(12) Patent Application Publication
(10) Pub. No.: US 2019/0333092 A1
(43) Pub. Date: Oct. 31, 2019

(54) CONSUMER CONVERSION JOURNEY (CCJ) AUTOMATION FOR PUSH CAMPAIGNS

(71) Applicant: Microsoft Technology Licensing, LLC, Redmond, WA (US)

(72) Inventors: Prabhakar Goyal, Sammamish, WA (US); Jayaram N.M. Nanduri, Issaquah, WA (US)

(21) Appl. No.: 15/967,426

(22) Filed: Apr. 30, 2018

(51) Int. Cl. G06Q 30/02; G06T 11/20

(52) U.S. Cl. CPC G06Q 30/0243; G06Q 30/0244; G06Q 30/0201; G06T 11/206

(57) ABSTRACT

A push marketing campaign is configured to convert users into purchasers of a product or service. A graph containing nodes and edges connecting the nodes is constructed. The graph represents paths for users of a product to transition from an entry state indicated as an entry node, through engagement states indicated as engagement nodes, to an objective state indicated as an objective node. Weights for the engagement nodes and a first set of probabilities for the edges are determined based on a first data set obtained without stimulus messaging. Each probability indicates a probability of users transitioning a corresponding edge of the graph. A second set of probabilities for the edges is determined based on a second data set that included stimulus messaging. A set of stimulus nodes of the graph for sending stimulus messages to users is selected to maximize the users that transition to the objective state.

### BACKGROUND

A push marketing campaign (also referred to as “push campaign”) is a type of marketing campaign that uses push marketing to entice users to purchase a product or service, turning the users from potential customers to actual purchasing customers. A push campaign may send emails to users, for example, to entice them to make the purchase. An “in-product” push campaign is a push marketing campaign performed within the confines of a particular product, such as a software application. For instance, an in-product push campaign may use push marketing to entice users of a software application to purchase a subscription to the software application, to purchase additional features for the software application, and/or to make other purchases associated with the software application.

Push campaigns tend to be closely managed by marketing professionals, and tend to be scripted. For instance, a marketing operations team may select the user segments to receive messaging, may define the actual messaging, the frequency of messaging, etc. A shallow set of contents typically go into the push messages, which may be hand-crafted. A campaign messaging tool may be used to send out the messages as configured by the marketing personnel.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for conducting a push marketing campaign to convert users into purchasers of a product or service, or any other such goal a marketer may have. For instance, a push marketing system may include a consumer conversion journey (CCJ) graph constructor, a CCJ coefficient generator, a CCJ optimizer, and a node selector. The CCJ graph constructor is configured to construct a graph containing nodes and edges connecting the nodes. The graph represents consumer journey paths for users of a product to transition from an entry state indicated as an entry node of the graph, through a plurality of engagement states indicated as engagement nodes of the graph, to an objective state indicated as an objective node of the graph. The CCJ coefficient generator is configured to determine weights for the engagement nodes and a first set of probabilities for the edges based on a first data set obtained without stimulus messaging. Each probability of the first set of probabilities indicates, for a corresponding edge, a probability of a user at a particular engagement node transitioning to another engagement node connected by that edge. The CCJ optimizer is configured to determine a second set of probabilities for the edges based on a second data set that included stimulus messaging. The node selector is configured to select, based at least on the second set of probabilities, a set of stimulus nodes for the graph for sending stimulus messages to users during a push campaign for the product.

Further features and advantages of embodiments, as well as the structure and operation of various embodiments, are described in detail below with reference to the accompanying drawings. It is noted that the methods and systems are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a computing device configured for managing a push campaign with stimulus messaging, according to an example embodiment.

FIG. 2 shows a flowchart for constructing a push campaign with stimulus messaging, according to an example embodiment.

FIG. 3 shows a block diagram of a stimulus-enhanced push campaign generator, according to an example embodiment.

FIG. 4 shows a block diagram of a consumer conversion journey (CCJ) graph constructor, according to an example embodiment

FIG. 5 shows a flowchart for constructing a CCJ graph, according to an example embodiment.

FIG. 6 shows a flowchart for confining a CCJ graph to high value nodes, according to an example embodiment.

FIG. 7 shows a block diagram of a CCJ coefficient generator, according to an example embodiment.

FIG. 8 shows a flowchart for determining a second set of probabilities for edges of a CCJ graph based on a second data set generated based in part on stimulus messaging, according to an example embodiment.

FIG. 9 shows a flowchart for selecting a set of stimulus nodes of a CCJ graph for sending stimulus messages to users, according to an example embodiment.

FIG. 10 shows a flowchart for performing a push campaign on users of a product, according to an example embodiment.

FIG. 11 shows a block diagram of an example CCJ graph including a first set of edge probabilities determined without stimulus messaging, according to an example embodiment.

FIG. 12 shows a block diagram of an example CCJ graph including a second set of edge probabilities determined with stimulus messaging, according to an example embodiment.

FIGS. 13A-13B show flowcharts for constructing a push campaign with personalized stimulus messaging, according to an example embodiment.

FIG. 14 is a block diagram of an example processor-based computer system that may be used to implement various embodiments.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

I. Introduction

The present specification and accompanying drawings disclose one or more embodiments that incorporate the features of the disclosed embodiments. The scope of the embodiments is not limited only to the aspects disclosed herein. The disclosed embodiments merely exemplify the intended scope, and modified versions of the disclosed embodiments are also encompassed. Embodiments are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

II. Example Embodiments.

A push marketing campaign (also referred to as “push campaign”) is a type of marketing campaign that uses push marketing to entice users to purchase a product or service, turning the users from potential customers to actual purchasing customers. For example, a push campaign may send emails to potential customers to entice them to make a purchase, and to existing customers to entice them to purchase an additional service and/or product, or to purchase an upgrade to a service or product they already own or pay for. Such emails may include product or service information, advertisements, coupons, discounts, and/or any other type of enticements to make a purchase.

An in-product push campaign is a push campaign performed within the confines of a particular product, such as a software application. For instance, an in-product push campaign may use push marketing to entice users of a software application to purchase a subscription to the software application, to purchase additional features for the software application, and/or to make other purchases associated with the software application.

Push campaigns tend to be closely managed by marketing professionals, and tend to be scripted. For instance, a marketing operations team may select the user segments to receive messaging, may define the actual messaging, the frequency of messaging, etc. A shallow set of contents typically go into the push messages, which may be hand-crafted. A campaign messaging tool/platform may be used to send out the messages as configured by the marketing personnel. The campaign messaging tool itself does little choosing or optimization beyond what is already dictated by the marketing operations team as part of campaign configuration.

For instance, a marketing operations teams may run a set of push campaigns geared towards pursuing existing customers of a product to renew their subscription, to convert trial users of the product into paid customers, to up-sell existing customers of the product (e.g., try to convince a customer of Microsoft Office® to use Microsoft OneDrive®), etc. These campaigns may be broken up into multiple interactions, where each interaction has a targeted segment that is manually defined and built by the operations team and an associated message with call-to-action. Furthermore, the marketing operations team may sequence and frequency cap the interactions to build out the overall campaign. The performance from each interaction and overall campaign is monitored by the marketing team, which then makes changes to underline segments, timeframe, frequency, etc. to manually optimize the overall campaign objective.

Accordingly, push campaign configuration for platforms can require a set of arduous steps, be highly scripted, be closely managed by marketing operations teams, and due to the volume of consumers, may be difficult for marketing operations teams to create the most effective targeted/personalized campaigns. Furthermore, due to the high touch nature of the overall process, marketing operations teams cannot easily scale push campaigns.

Embodiments overcome these and other issues related to push marketing campaign configurations. In embodiments, a graph is constructed that contains nodes corresponding to states of a product, and edges corresponding to actions the product users can take to transition between the product states. The graph represents the various consumer journey paths for users that use the product towards the possibility of a defined objective (e.g., making a purchase related to the product such as a subscription, etc.). The graph is used to determine stimulus nodes at which marketing messages, referred to herein as “stimulus messages,” are transmitted to users to encourage the users to transition towards achieving that objective. In other words, the constructed graph enables the modeling of the product in the form of nodes and edges that can be traversed by users, and improved selection of stimulus nodes for targeted stimulus messages, to maximize user conversion as identified by the marketer. Embodiments enable the operational scale of push campaigns to be increased, along with improving push campaign targeting/personalization, which improves the effectiveness of push campaigns. Embodiments enable the user to be encouraged to be moved through the product states to the objective.

Embodiments enable the modeling and honing of a CCJ graph for a product, which is used to identify states of the product for sending of push marketing messages to users to encourage the users to perform an objective (e.g., purchase a subscription to the product). The product may be any type of product, including software applications used by consumers. Examples of such software applications include proprietary or commercially available application, such as applications sold by Microsoft Corporation, Google LLC, Apple Inc., Oracle Corporation, smaller app developers, etc.

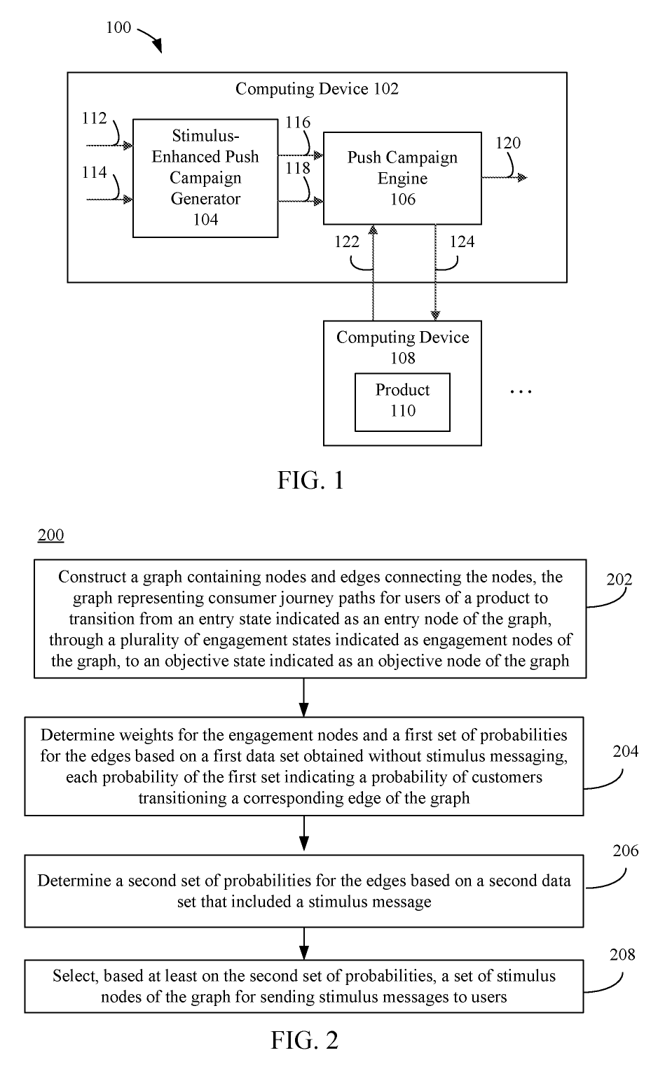

Such embodiments may be implemented in various ways. For instance, FIG. 1 shows a block diagram of a stimulus-enhanced push campaign system 100 containing a computing device 102 configured for managing a push campaign with stimulus messaging, according to an example embodiment. As shown in FIG. 1, system 100 includes a first computing device 102 and a second computing device 108. Computing device 102 includes a stimulus-enhanced push campaign generator 104 and a push campaign engine 106. Computing device 108 includes a product 110. It is noted that although a single computing device 108 is shown in system 100, it should be understood that any number of computing devices may exist in system 100, and each computing device may include any number of products. FIG. 1 is described as follows.

Computing device 108 may be any type of mobile computing device (e.g., a Microsoft® Surface® device, a personal digital assistant (PDA), a laptop computer, a notebook computer, a tablet computer such as an Apple iPad™, a netbook, etc.), a mobile phone (e.g., a cell phone, a smart phone such as a Microsoft Windows® phone, an Apple iPhone, a phone implementing the Google® Android™ operating system, a Palm® device, a Blackberry® device, etc.), or a stationary computing device such as a desktop computer or PC (personal computer), a gaming console/system (e.g., Microsoft Xbox®, Sony PlayStation®, Nintendo Wii® or Switch®, etc.), etc. Computing device 102 may be any type of computing device, mobile or stationary, including one or more servers.

As shown in FIG. 1, computing device 102 includes stimulus-enhanced push campaign generator 104 and push campaign engine 106. Stimulus-enhanced push campaign generator 104 is configured to generate push campaigns for products, the generating push campaigns including nodes selected for stimulus messaging. In particular, with respect to product 110, stimulus-enhanced push campaign generator 104 is configured to receive product data 112 of product 110. Product data 112 includes information regarding the actions that may be performed by users that use product 110. For example, users of a document management application may be enabled to perform specific actions such as open file, save file, copy file, share file, etc., as well as perform higher-level actions, such as log in, use application on mobile device, use application on desktop device, purchase subscription to application, etc. A product may have any number of associated actions. When a user performs an action in product 110, the user transitions to a state of product 110, and when the user performs another action in product 110, the user transitions to another state of product 110, which may the same or a different state. As such, product 110 may have any number of states.

Stimulus-enhanced push campaign generator 104 is further configured to receive data sets, including a first data set 114. First data set 114 is a historical set of data collected from computing devices of users that use product 110. First data set 114 indicates how many users of product 110 performed each possible action, and in what sequence the users performed the actions, so that the transition of states of product 110 by the users may be determined.

Based on first data set 114, stimulus-enhanced push campaign generator 104 is configured to generate a CCJ graph 116. CCJ graph 116 contains nodes that represent the states of product 110, and edges connecting the nodes that represent the actions that may be performed by the users of product 110. The edges are directional, with each edge transitioning from a corresponding source node to a corresponding destination node. For instance, the CCJ graph may include an entry state, a set of engagement states, and an objective state. At the entry state, the user of product 110 may begin to use product 110 on a journey to get to the objective state, the journey passing through the set of engagement states. The engagement states are the states of product 110 at which a user can interact with product 110 to perform an action and transition to another state, including another engagement state or the objective state. Some engagement states are considered by stimulus-enhanced push campaign generator 104 to be key (“high value”), due to being determined to be states that users frequently travel though to get from the entry state to the objective state. As such, an engagement state is associated with a key user action within product 110. Any number of paths through the engagement states may exist between the entry and objective states.

Furthermore, stimulus-enhanced push campaign generator 104 may generate weights and probabilities for the nodes (states) and edges (actions), respectively. Each node in CCJ graph 116 may be assigned a weight, corresponding to a percentage of users of product 110 (in first data set 114) that arrived at the corresponding state by performing the action(s) leading to that state. Still further, each edge of CCJ graph 116 may be assigned a probability, which is a probability that a user at the source node of the edge will perform the action associated with the edge to transition to the destination node of the edge.

Based in part on CCJ graph 116, including the weights and probabilities, stimulus-enhanced push campaign generator 104 is configured to determine a number of stimulus messages to send to users of product to attempt to convert the users (i.e., to transition the users from the entry node/state to the objective node/state), and in particular at which engagement nodes in CCJ graph 116 to push those stimulus messages to the users. Stimulus-enhanced push campaign generator 104 indicates the number of stimulus messages, and the set of nodes at which to push those stimulus messages to the users—the “stimulus nodes”—in stimulus information 118.

Note that in an embodiment, to hone in on the most beneficial number of stimulus messages and set of stimulus nodes, stimulus-enhanced push campaign generator 104 may conduct one or more test push campaigns (or access push campaign engine 106 to perform the test push campaign(s)). A test push campaign may use a set number of stimulus messages for each user and send the stimulus messages at a predetermined set of nodes, or may vary the number of stimulus messages sent to users, and vary the nodes at which the stimulus messages are sent to the users, to collect data on what actions the users performed in response to the stimulus messages, and how successful the test messages were in transitioning the users to the objective state. The results of the test push campaigns may be used by stimulus information 118 to adjust (e.g., recalculate) the weights and probabilities assigned to the nodes and probabilities, respectively, and thereby generate an improved number of stimulus messages and set of stimulus nodes, indicated in stimulus information 118.

Note that the stimulus messages sent to different nodes for different users during a push campaign may have the same content or may have different content. For example, in general, a stimulus message may include marketing information to encourage the recipient to transition through CCJ graph 116 to the objective node. For a particular node, different users that transition to the node may receive a same stimulus message with the same content, or a different stimulus message with content that is calibrated for the particular user and different than that sent to other users. The content of a stimulus message may be calibrated for a particular node (e.g., configured to encourage a user at node corresponding to an “opened document” state to share the opened document, so that the user advances to the “shared document” state), or may be generic to multiple nodes (e.g., configured to encourage a user at each node to purchase a subscription to the product).

In an embodiment, push campaign engine 106 receives CCJ graph 116 from stimulus-enhanced push campaign generator 104. Push campaign engine 106 is configured to execute a push campaign with respect to users of product 110 based on CCJ graph 116. In particular, push campaign engine 106 is configured to send push marketing messages 120 to users of product 110, including a user of product 110 at computing device 108. In an embodiment, push campaign engine 106 receives stimulus information 118. As described above, stimulus indication 118 indicates a number of stimulus messages for push campaign engine 106 to send to each user of a user set during an iteration of a push campaign for product 110. Push campaign engine 106 is configured transmits the stimulus messages to the users of product 110 that reach the indicated stimulus nodes in CCJ graph 116.

Note that by limiting stimulus messages to being sent to users arriving at a set of stimulus nodes, rather than sending stimulus messages the users at every node that they transition into, embodiments relieve the users of being bombarded by large numbers of messages and becoming disgruntled. Instead, embodiments enable the number of stimulus messages/nodes to be calibrated to have most beneficial effect in encouraging users to transition to the objective state, which may mean purchasing a subscription to product 110 (e.g., a software application), and/or performing something else beneficial with regard to product 110.

In embodiments, and discussed in detail hereinafter, stimulus-enhanced push campaign generator 104 is configured to optimize CCJ graphs. Once optimized, stimulus-enhanced push campaign generator 104 is configured to further optimize the CCJ based on stimulus messaging. For instance, and in embodiments, push campaign engine 106 is configured to apply stimulus messages to consumer computing devices and obtain stimulus results. For example, and as shown in FIG. 1, push campaign engine 106 is configured to apply stimulus messages to computing device 108 and obtain stimulus results. Push campaign engine 106 is further configured to transmit the stimulus results to stimulus-enhanced push campaign generator 104 such that further CCJ graph optimization can occur.

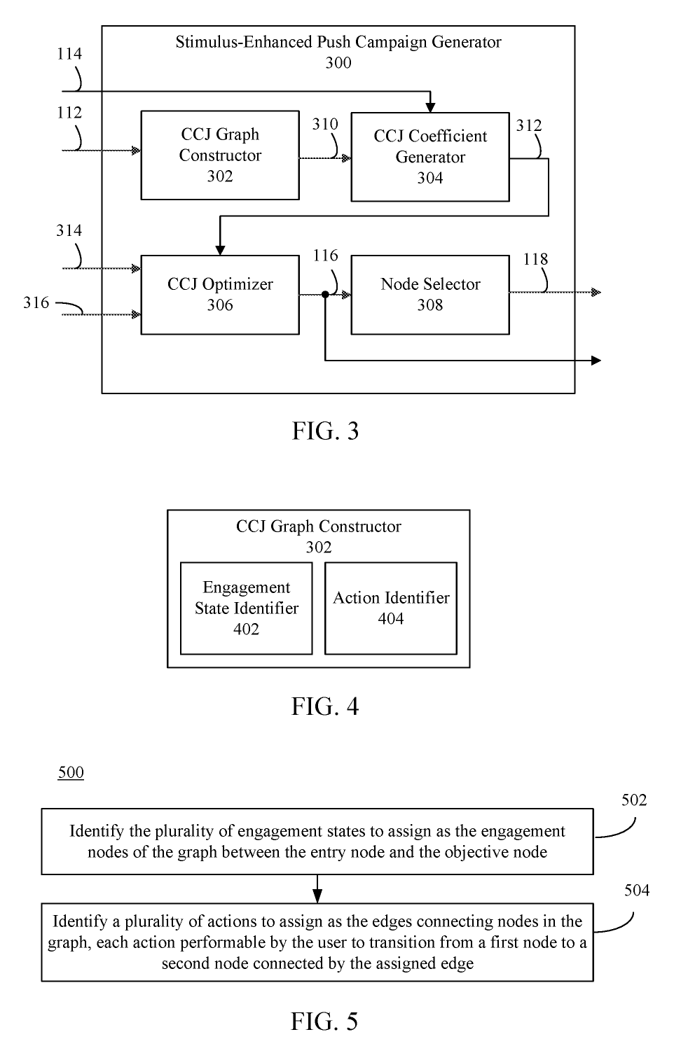

In embodiments, system 100 may operate in various ways to perform its functions. For example, FIG. 2 shows a flowchart 200 for constructing a push campaign with stimulus messaging, according to an example embodiment. In an embodiment, flowchart 200 may be implemented by stimulus-enhanced push campaign generator 104. For the purposes of illustration, flowchart 200 of FIG. 2 is described with continued reference to FIG. 1 and with respect to FIG. 3. FIG. 3 shows a block diagram of a stimulus-enhanced push campaign generator 300, according to an example embodiment. Stimulus-enhanced push campaign generator 300 is an example of stimulus-enhanced push campaign generator 104 of FIG. 1. As shown in FIG. 3, stimulus-enhanced push campaign generator 300 includes a CCJ graph constructor 302, a CCJ coefficient generator 304, a CCJ optimizer 306, and a node selector 308. Other structural and operational embodiments will be apparent to persons skilled in the relevant art(s) based on the following discussion regarding flowchart 200 and stimulus-enhanced push campaign generator 300 and FIG. 3.

Flowchart 200 of FIG. 2 begins with step 202. In step 202, a graph containing nodes and edges connecting the nodes is constructed where the graph represents consumer journey paths for users of a product to transition from an entry state indicated as an entry node of the graph, through a plurality of engagement states indicated as engagement nodes of the graph, to an objective state indicated as an objective node of the graph. For instance, with reference to FIG. 3, CCJ graph constructor 302 may be configured to construct a basic CCJ graph 310 for product 110 based on product data 112 of product 110. As indicated above, product data 112 includes time sequences of user journeys using product 110, the time sequences indication sequences of actions performed in product 110 by the users. Basic CCJ graph 310 indicates these times sequences in the forms of nodes and edges, with each node indicating an engagement state in product 110, and each edge indication an action performed by the user in product 110 to transition from a source node/state to a destination node/state.

CCJ graph constructor 302 may be configured in various ways to construct CCJ graph 310. For example, FIG. 4 shows a block diagram of CCJ graph constructor 302, according to an example embodiment. As shown in FIG. 4, CCJ graph constructor 302 of FIG. 4 includes an engagement state identifier 402 and an action identifier 404. In an embodiment, CCJ graph constructor 302 of FIG. 4 operates according to FIG. 5. FIG. 5 shows a flowchart 500 for constructing a CCJ graph, according to an example embodiment. Flowchart 500 may be performed, for example, as part of step 202 according to flowchart 200 as described above. Other structural and operational embodiments will be apparent to persons skilled in the relevant art(s) based on the following discussion regarding flowchart 500.

Flowchart 500 begins with step 502. In step 502, the plurality of engagement states is identified to assign as the engagement nodes of the graph between the entry node and the objective node. For instance, and with reference to FIG. 4, engagement state identifier 402 identifies the engagement states of product 110 to assign as the engagement nodes of basic CCJ graph 310. For example, engagement state identifier 402 may parse product data 112 for the engagement states. Each engagement state may correspond to a sequence of one or more actions having been performed by a user of product 110. For instance, a user agreeing to be a trial user of product 110 (e.g., by filling in an online form) may be considered at an entry state of product 110. The user may login to product 110 to transition to a first engagement state of product 110 (e.g., a logged in state). The user may then save a document using product 110 to transition to a second engagement state of product 110 (e.g., a document saved state), etc. Accordingly, engagement state identifier 402 may parse product data 112 for all engagement states corresponding to completed actions, to include in basic CCJ graph 310.

In step 504, a plurality of actions is identified to assign as the edges connecting the nodes in the graph, where each action is performable by the user to transition from a first node to a second node connected by the assigned edge. For instance, with reference to FIG. 4, action identifier 404 may be configured to parse product data 112 to identify the actions that users can performing using product 110, and to assign each action to an edge connecting the source state (the state immediately prior to performing the action) to the destination state (the state upon completion of the action). For instance, continuing the above example, a logged in user saving a document using product 110 may be considered to have performed a document save action, which is connected between the logged in state (source state) to a document saved state (destination state). Accordingly, action identifier 404 may parse product data 112 for all actions to assign as edges in basic CCJ graph 310.

Note that in one embodiment, basic CCJ graph 310 may include a node for all states of product 110 indicated in product data 112. In another embodiment, CCJ graph constructor 302 may reduce the number of nodes in basic CCJ graph 310 relative to the total number of states of product 110. For instance, CCJ graph constructor 302 may “trim” the number of nodes such that nodes considered important (e.g., “high value”) are included in basic CCJ graph 310, while relatively unimportant nodes are not included in basic CCJ graph 310. By trimming the total number of nodes in this manner, subsequent operations performed on CCJ graph data are simplified (e.g., reducing the number of nodes to process, resulting in a corresponding reduced number of calculations, a reduced number of processor operations, a reduced amount of memory consumed, etc.).

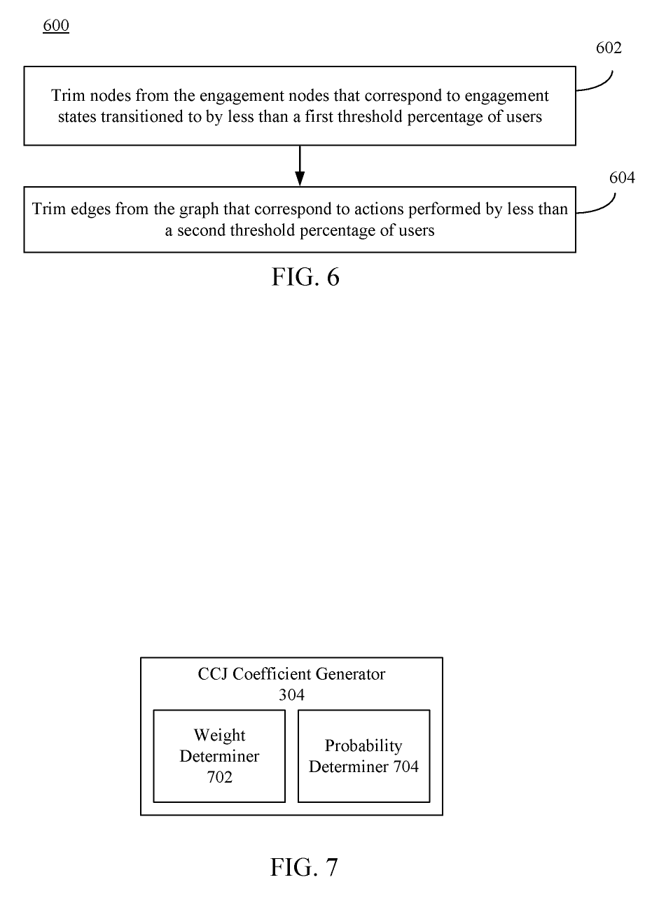

For instance, CCJ graph constructor 302 may operate according to FIG. 6. FIG. 6 shows a flowchart 600 for confining a consumer conversion journey (CCJ) graph to high value nodes, according to an example embodiment. Flowchart 600 may be performed as an initial step to flowchart 200 (FIG. 2), as part of step 202, or in another manner. Flowchart 600 is described as follows. Other structural and operational embodiments will be apparent to persons skilled in the relevant art(s) based on the following discussion regarding flowchart 600.

Flowchart 600 begins with step 602. In step 602, the engagement nodes are trimmed of nodes that correspond to engagement states transitioned to by less than a first threshold percentage of users. For instance, with reference to FIG. 3, CCJ graph constructor 302 is configured to trim nodes from basic CCJ graph 310 that correspond to engagement states transitioned to by less than a first threshold percentage of users. In other words, states that are transitioned to by a relatively low number of users are considered unimportant, and thus may be removed from basic CCJ graph 310. A first threshold percentage of users may be selected as a cut off. Nodes transitioned to by a percentage of users less than the first threshold are removed from basic CCJ graph 310. For example, for a total number of users of 1000, if the first threshold percentage of users is 25%, CCJ graph constructor 302 would trim nodes traversed to by less than 250 users.

In step 604, the edge nodes are trimmed from the graph that correspond to actions performed by less than a second threshold percentage of users. For instance, with reference to FIG. 3, CCJ graph constructor 302 is configured to trim edges from basic CCJ graph 310 that correspond to actions performed by less than a second threshold percentage of users. In other words, edges corresponding to actions that are performed by a relatively low number of users are considered unimportant, and thus may be removed from basic CCJ graph 310. For example, for a total number of users of 1000, if the second threshold percentage of users is 25%, CCJ graph constructor 302 would trim edges traversed by less than 250 users.

Referring back to FIG. 2, in step 204, weights for the engagement nodes and a first set of probabilities for the edges are determined based on a first data set obtained without stimulus messaging where each probability of the first data set indicates a probability of users transitioning a corresponding edge of the graph. For instance, as shown in FIG. 3, CCJ coefficient generator 304 receives basic CCJ graph 310. CCJ coefficient generator 304 is configured to determine weights for the engagement nodes and a probability for each of the edges indicated in basic CCJ graph 310, based on first data set 114. As described above, first data set 114 is a historical set of data collected from computing devices of users that use product 110, indicating how many users performed each action, and in what sequence of states the users transitioned through in performing the actions.

In an embodiment, first data set 114 is obtained without stimulus messaging. In other words, first data set 114 contains data collected from users interacting with product 110 in the absence of any push marketing messages being sent to them with regard to their use of product 110. In this manner, first data set 114 can be considered a baseline set of user data.

CCJ coefficient generator 304 may be configured to generate edge probabilities and node weights based on first data set 114 in any manner. For instance, CCJ coefficient generator 304 may be configured as shown in FIG. 7. FIG. 7 shows a block diagram of CCJ coefficient generator 304, according to an example embodiment. As shown in FIG. 7, CCJ coefficient generator 304 includes a weight determiner 702 and a probability determiner 704. FIG. 7 is described as follows.

Weight determiner 702 is configured to determine weights for the engagement nodes based on first data set 114, and may do so in any suitable manner. In an embodiment, weight determiner 702 generates the weight of each node as an indication of a number of users that transitioned to the state corresponding to the node. For instance, weight determiner 702 may calculate a node weight as the number of users that transitioned to the corresponding state (a number value), or as the number of users that transitioned to the corresponding state divided by the total number of users having data in first data set 114 indication interactions with product 110 (a percentage value).

Furthermore, probability determiner 704 is configured to determine, based on first data set 114, the first set of probabilities. In an embodiment, probability determiner 704 calculates each edge probability as a probability that a user transitions the edge. For example, probability determiner 704 may calculate an edge probability as the number of users that transition over the edge (from the source node to the destination node) by performing the corresponding action, divided by the total number of users that had arrived at the source node.

For example, first data set 114 for product 110 (e.g., Microsoft PowerPoint®) may indicate that the total number of users is 1,000, the number of users that transitioned from the entry node to the first node is 600, the number of users that transitioned to the second node from the first node is 420, the number of users that transitioned to the third node from the second node is 200, and the number of users that transitioned to the objective node from the third node is 300. Accordingly, weight determiner 702 may determine that the weight of the entry node is 1,000, the weight of the first engagement node is 600, the weight of the second engagement node is 250, the weight of the third engagement node is 80, and the weight of the objective node is 51. Furthermore, probability determiner 704 may determine the edge probability from the entry node to the first engagement node is 0.6 (60%), the edge probability from the first to the second engagement node is 0.42 (42%), the edge probability from the second to the third engagement node is 0.2 (20%), and the edge probability from the third node to the objective node is 0.3 (30%).

Note that in embodiments, first data set 114 may be based on historical data derived from all available consumers, a subset of available consumers, or a single consumer. Alternatively, first data set 114 may be modeled user data. As shown in FIG. 3, CCJ coefficient generator 304 generates baseline CCJ graph 312, which includes the constructed graph of base CCJ graph 310, with the nodes and edges thereof assigned the node weights and edge probabilities generated by CCJ coefficient generator 304.

Referring back to FIG. 2, in step 206, a second set of probabilities for the edges is determined based on a second data set that includes a stimulus message. For instance, with reference to FIG. 3, CCJ optimizer 306 receives baseline CCJ graph 312, a second data set 314, and a message number indication 316. Message number indication 316 is an indication of a number of stimulus messages to send to each user during a push marketing campaign for product 110. The number may be provided by a person, such as a person on a marketing team that desires to run the push marketing campaign, may be pre-selected, may be generated automatically, or a sequence of numbers may be iterated through by CCJ optimizer 306 Similar to first data set 114, second data set 314 is a set of data collected from computing devices of users that use product 110, indicating how many users performed each action, and in what sequence of states the users transitioned through in performing the actions. Second data set 314, however, is obtained with stimulus messaging. In other words, second data set 314 contains data collected from users interacting with product 110 with push marketing messages being sent to them at one or more engagements states during their use of product 110. In this manner, second data set 314 can be considered a stimulus-affected set of user data. After second data set 314 is obtained, CCJ optimizer 306 is configured to determine the second set of probabilities for the edges of baseline CCJ graph 312.

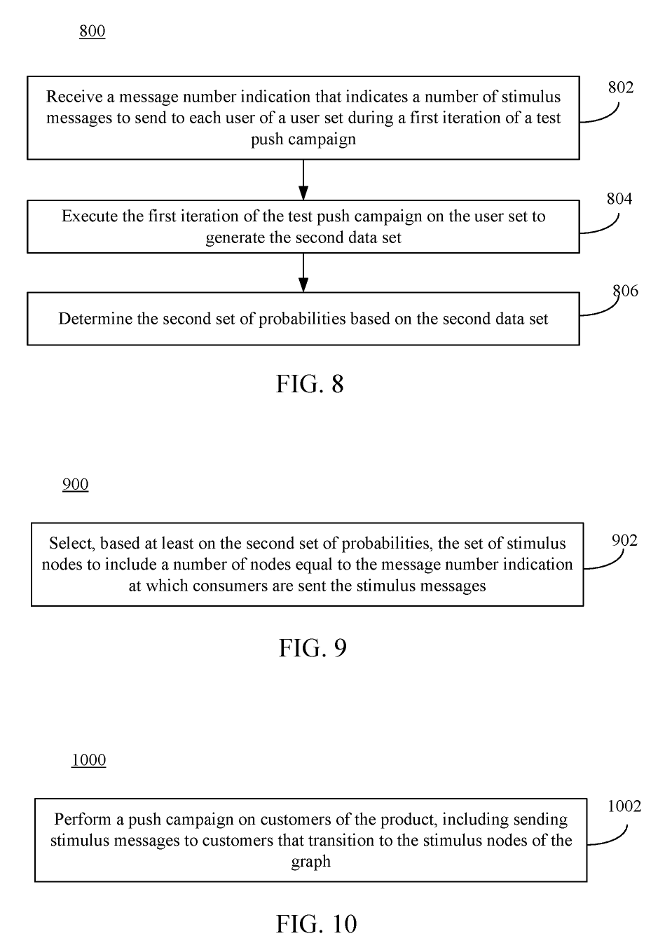

CCJ optimizer 306 may perform step 206 of flowchart 200 in various ways. For instance, CCJ optimizer 306 may operate according to FIG. 8. FIG. 8 shows a flowchart 800 for determining a second set of probabilities for edges of a CCJ graph based on a second data set generated based in part on stimulus messaging, according to an example embodiment. Flowchart 800 is described as follows. Other structural and operational embodiments will be apparent to persons skilled in the relevant art(s) based on the following discussion regarding flowchart 800.

Flowchart 800 begins with step 802. In step 802, a message number indication is received that indicates a number of stimulus messages to send to each user of a user set during a first iteration of a test push campaign. For instance, with reference to FIG. 3 CCJ optimizer 306 is configured to receive message number indication 316. Message number indication 316 indicates a number of stimulus messages to send to each user of a user set during a first iteration of a test push campaign. Message number indication 316 may indicate any number of stimulus messages (e.g., marketing emails, marketing text messages, etc.), such as one, two, three, or greater numbers of stimulus messages.

At step 804, the first iteration of the test push campaign on the user set is executed to generate the second data set. For instance, as described above with reference to FIG. 3 and FIG. 4, CCJ optimizer 306 is configured to execute an iteration of a test push campaign on the user set to generate second data set 314. In an embodiment, push campaign engine 106 may conduct push marketing to the users of product 110 under the instructions of CCJ optimizer 306 to generate second data set 314. CCJ optimizer 306 may instruct push campaign engine 106 to transmit the number of stimulus messages of message number indication 316 to each user of product 110 during the push campaign by selecting particular engagement states at which to send push messages to users. Push campaign engine 106 may be configured to track the sequence of nodes transitioned by each user of product 110 during the push campaign, and the stimulus messages that are sent to the users, and provide this information to CCJ optimizer 306 as second data set 314. In another embodiment, CCJ optimizer 306 may receive second data set 314 from a source other than push campaign engine 106.

At step 806, the second set of probabilities is determined based on the second data set. For example, CCJ optimizer 306 may be configured to determine a second set of probabilities based on second data set 314. In an embodiment, CCJ optimizer 306 may instruct CCJ coefficient generator 304 to generate new edge probabilities for the edges in baseline CCJ graph 312 based on second data set 314. In an embodiment, probability determiner 704 of CCJ coefficient generator 304 may calculate each new edge probability as a probability that a user transitions the edge. For example, probability determiner 704 may calculate a new edge probability as the number of users in second data set 314 that transitioned the edge (performing the action to transition from the source node to the destination node), divided by the total number of users indicated in second data set 314 to have arrived at the source node. As shown in FIG. 3, CCJ optimizer 306 generates CCJ graph 116, which includes the nodes, edges, and node weights of baseline CCJ graph 312, and the new edge probabilities determined by probability determiner 704. In another embodiment, CCJ optimizer 306 may re-calculate the node weights based on second data set 314, in a manner as described elsewhere herein.

For instance, continuing the prior Microsoft PowerPoint® example, a push campaign may be performed on users of the product using single stimulus message (e.g., an email, a text message, or other type of push stimulus message) applied at the entry node. In such an example, CCJ optimizer 306 (or weight determiner 702) may determine from second data set 314 that the weight of the entry node is 1,000, the weight of the first engagement node is 660, the weight of the second engagement node is 277, the weight of the third engagement node is 87, and the weight of the objective node is 55. Second data set 314 may further indicate that the total number of users is 1,000, the number of users that transitioned from the entry node to the first node is 660, the number of users that transitioned to the second node from the first node is 420, the number of users that transitioned to the third node from the second node is 200, and the number of users that transitioned to the objective node from the third node is 300. Accordingly, CCJ optimizer 306 (or probability determiner 704) may determine the new edge probability from the entry node to the first engagement node is 0.66 (66%), the new edge probability from the first engagement node to the second engagement node is 0.42 (42%), the new edge probability from the second engagement node to the third engagement node is 0.2 (20%) and the new edge probability from the third engagement node to the objective node is 0.30 (30%).

Referring back to FIG. 2, in step 208, a set of stimulus nodes of the graph for sending stimulus messages to users is selected based at least on the second set of probabilities. For instance, with reference to FIG. 3, node selector 308 receives CCJ graph 116. Based on CCJ graph 116, node selector 308 is configured to select a set of nodes of CCJ graph 116 to be stimulus nodes where users at the nodes are sent stimulus messages. Node selector 308 may select the stimulus nodes from CCJ graph 116 in any manner.

For example, in an embodiment, node selector 308 may select the stimulus nodes according to FIG. 9. For instance, FIG. 9 shows a flowchart 900 for selecting a set of stimulus nodes of a CCJ graph for sending stimulus messages to users, according to an example embodiment. In step 902 of flowchart 900, the set of stimulus nodes is selected, based at least on the second set of probabilities, to include a number of nodes equal to the message number indication at which consumers are sent the stimulus messages. Accordingly, in an embodiment, node selector 308 may be configured to select the set of stimulus nodes to include a number of nodes equal to message number indication 316. As shown in FIG. 3, node selector 308 generates stimulus information 118, which indicates the selected set of stimulus nodes of CCJ graph 116.

Node selector 308 may operate in various ways to select the particular engagement nodes to include in the set of stimulus nodes. For instance, node selector 308 may analyze CCJ graph 116 in the form of a flow optimization problem in the field of optimization theory. For example, node selector 308 may analyze CCJ graph 116 in the form of a maximum flow problem, which involves finding a feasible flow through a single-source, single-sink flow network that is maximum, and which in this case, would mean traversing a maximum number of users from the entry node to the objective node. According to the maximum flow problem, each directed edge between nodes has a flow capacity (a maximum amount of flow the edge can deliver) and a calculated flow amount that is equal to or less than the flow capacity of the edge.

Node selector 308 may implement one or more of a variety of maximum flow problem solvers, including a linear programming algorithm, the Ford-Fulkerson algorithm, the Dinic's blocking flow algorithm, the MPM (Malhotra, Pramodh-Kumar, and Maheshwari) algorithm, Dinic's algorithm, General push-relable maximum flow algorithm, etc. In one embodiment, node selector 308 may solve the maximum flow algorithm for second data set 314 by setting the flow capacity for each edge to the percentage of users that traverse the edge after receiving a stimulus message at the source node, then calculating the flow amount for each edge, and then selecting a number of nodes (equal to the message number indication) having the greatest numbers of users that flow through them to be the stimulus nodes. In other embodiments, node selector 308 may select the stimulus nodes in other ways.

Once the stimulus nodes are selected, push campaign engine 106 of FIG. 1 may be enabled to perform a push campaign. For instance, FIG. 10 shows a flowchart 1000 for performing a push campaign on users of a product, according to an example embodiment. Flowchart 1000 may be implemented by push campaign engine 106 of FIG. 1, in embodiments. Flowchart 1000 is described as follows. Other structural and operational embodiments will be apparent to persons skilled in the relevant art(s) based on the following discussion regarding flowchart 1000.

Flowchart 1000 begins with step 1002. In step 1002, a push campaign is performed on users of the product, including sending stimulus messages to users that transition to the stimulus nodes of the graph. For instance, and with reference to FIG. 1, push campaign engine 106 performs a push campaign on users of the product 110. During the push campaign, users begin at an entry node (e.g., the user begins a trial subscription, an existing customer enters a final time period of an existing subscription that is up for renewal, the product begins upselling effort on a user that is an existing customer, etc.). The users take actions related to product 110, which cause the users to transition along edges between states corresponding to nodes of CCJ graph 116. When a user arrives at an engagement node indicated as a stimulus node, push campaign engine 106 transmits a stimulus message to the user to encourage the user to move directly or eventually to the objective node. A user may receive a number of stimulus messages up to the message number indication 316 if the user transitions to all of the stimulus nodes indicated in stimulus information 118. In this manner, users are encouraged to move to the objective node, which is beneficial to the user and the manager of the push campaign, due to the user making a purchase (e.g., becoming a customer by purchasing a subscription, renewing a subscription, or purchasing the upsell product) or taking other desired action.

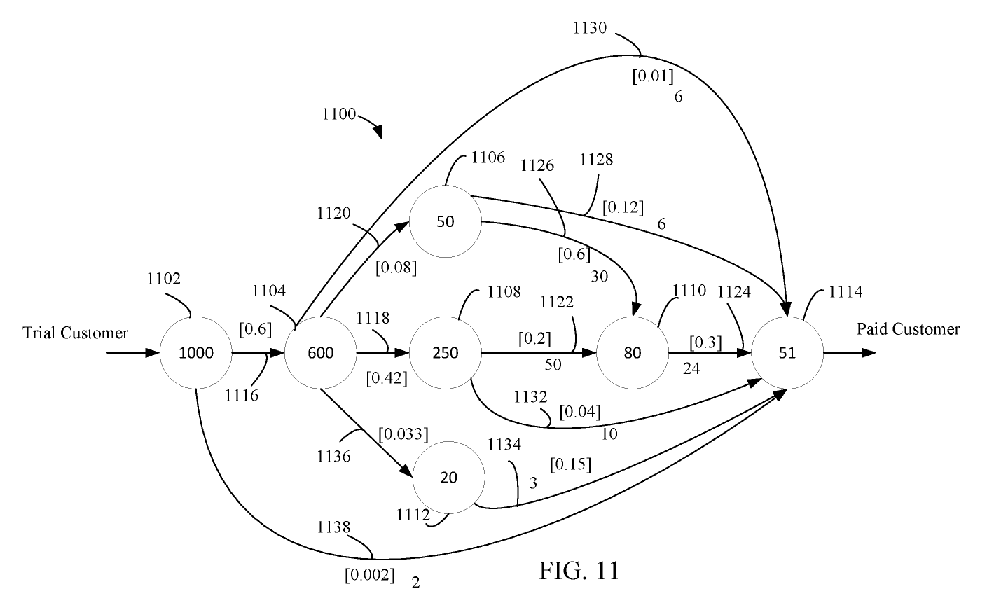

As described above, stimulus-enhanced push campaign generator 300 constructs CCJ graphs for products, where the CCJ graphs are formed of nodes and edges connecting the nodes, and including weights for the engagement nodes and probabilities for the edges. Such graphs may have any number and arrangement of nodes and edges, depending on the way the product is used by users. For example, FIG. 11 shows a block diagram of an example CCJ graph 1100, according to an embodiment. CCJ graph 1100 is an example of baseline CCJ graph 312. As shown in FIG. 11, graph 1100 includes a node 1102, a node 1104, a node 1106, a node 1108, a node 1110, a node 1112, a node 1114, an edge 1116, an edge 1118, an edge 1120, an edge 1122, an edge 1124, an edge 1126, and edge 1128, an edge 1130, an edge 1132, an edge 1134 an edge 1136, and an edge 1138. Edge 1116 is directed from node 1102 to node 1104, edge 1118 is directed from node 1104 to node 1108, edge 1120 is directed from node 1104 to node 1106, edge 1122 is directed from node 1108 to node 1110, edge 1124 is directed from 1110 to node 1114, edge 1126 is directed from node 1106 to node 1110, edge 1128 is directed from node 1106 to node 1114, edge 1130 is directed from node 1104 to node 1114, edge 1132 is directed from node 1108 to node 1114, node 1134 is directed from node 1112 to node 1114, node 1136 is directed from node 1104 to node 1112, and node 1138 is directed from node 1102 to node 1114. Node 1102 is the entry node and contains an initial weight, each of nodes 1102-1114 are assigned weights, as determined by the number of users that transition to each of them, and each of edges 1116-1138 have determined probabilities.

In one illustrative example, CCJ graph 1100 represents a graph for users of the Microsoft Office® toolset such that entry node 1102 represents an entry state representing a number of trial users trying out the toolset, objective node 1114 represents an objective state representing users converted to paid customers of the toolset and engagement nodes 1104-1112 represent various engagement states in between entry and objective nodes 1102 and 1114. In accordance with the above example, node 1102 represents the total number of trial users of Microsoft Office® and node 1114 represents the total number of paid customers based on graph 1100. Initially, and as shown in FIG. 11, node 1102 has a weight of 1,000 indicating 1,000 users at node 1102 and has two outgoing edge probabilities for edge 1116 to node 1104 and edge 1138 to node 1114, described as follows.

For instance, since the edge probability of edge 1116 from node 1102 to node 1104 is 0.6 (60%), the contributing weight to node 1104 is 600 or 60% of 1,000. This means that in this example, there is a 60% chance that a trial user of Microsoft Office® will open or log into Microsoft Office® via this edge. Likewise, and as shown in FIG. 11, the edge probability of edge 1138 from node 1102 to node 1114 is 0.002 (0.2%). Thus, there is a 0.2% chance (resulting in 2 users contributing to the weight of node 1114) that a trial user will become a paid customer via this edge.

Focusing now on node 1104, and as shown in FIG. 11, the edge probability of edge 1130 from node 1104 to node 1114 is 0.01 (10%). Thus, there is a 10% chance (resulting in 6 users contributing to the weight of node 1114) that a trial user will become a paid customer after logging into Office® via this edge. As further show in FIG. 11, the edge probability of edge 1120 from node 1104 to node 1106 is 0.08 (8%), the edge probability of edge 1118 from node 1104 to node 1108 is 0.42 (42%), and the edge probability of edge 1136 from node 1104 to node 1112 is 0.033 (3.3%). Accordingly, the contributing weights to nodes 1106, 1108 and 1112 are 50, 250, and 20, respectively. For instance, if node 1106 represents a trial user saving a document on Microsoft One Drive® after opening or logging into Office®, then there is an 8% chance a trial user will save a document on One Drive® after logging into Office®. Additionally, if node 1108 represents a trial user saving a document in Office® after opening or logging into Office®, there is a 42% chance a trial user will save a document on Office® after logging into Office®. Lastly, if node 1112 represents a trial user using Office® on both a mobile and desktop computing device after opening or logging into Office®, there is a 3.3% chance a trial user will use Office® on both a mobile and desktop computing device after logging into Office®.

Focusing now on node 1106, and as shown in FIG. 11, the edge probabilities of edge 1128 from node 1106 to node 1114 and edge 1126 from node 1106 to node 1110 are 0.12 (12%) and 0.6 (60%), respectively. Accordingly, from node 1106, there is a 12% chance (resulting in 6 users contributing to the weight of node 1114) that a trial user will become a paid customer after saving a document. Furthermore, and in an example, if node 1110 represents a trial user sharing a document, then from node 1106, there is a 60% chance (resulting in 30 users contributing to the weight of node 1110) that a trial user will share a document after saving a document.

Focusing now on node 1112, and as shown in FIG. 11, the edge probability of edge 1134 from node 1112 to node 1114 is 0.15 (15%). Thus, in an example and from node 1112, there is a 15% chance (resulting in 3 users contributing to the weight of node 1114) that a trial user will become a paid customer after using Office® on both a mobile and desktop computing device.

Focusing now on node 1108, and as shown in FIG. 11, the edge probability of edge 1132 from node 1108 to node 1114 is 0.04 (4%). Thus, in an example and from node 1108, there is a 4% chance (resulting in 10 users contributing to the weight of node 1114) that a trial user will become a paid customer after saving a document. Furthermore, the edge probability of edge 1122 from node 1108 to 1110 is 0.2 (20%). Thus, in an example and from node 1108, there is a 20% chance (resulting in 50 users contributing to the weight of node 1110) that a trial user will share a document after saving a document.

Focusing now on node 1110, and as shown in FIG. 11, the edge probability of edge 1124 from node 1110 to node 1114 is 0.3 (30%). Thus, in an example and from node 1110, there is a 30% chance (resulting in 24 users contributing to the weight of node 1114) that will become a paid customer after saving a document. Accordingly, as shown in FIG. 11, based on graph 1100, the resulting paid customers without stimulus are 51 users.

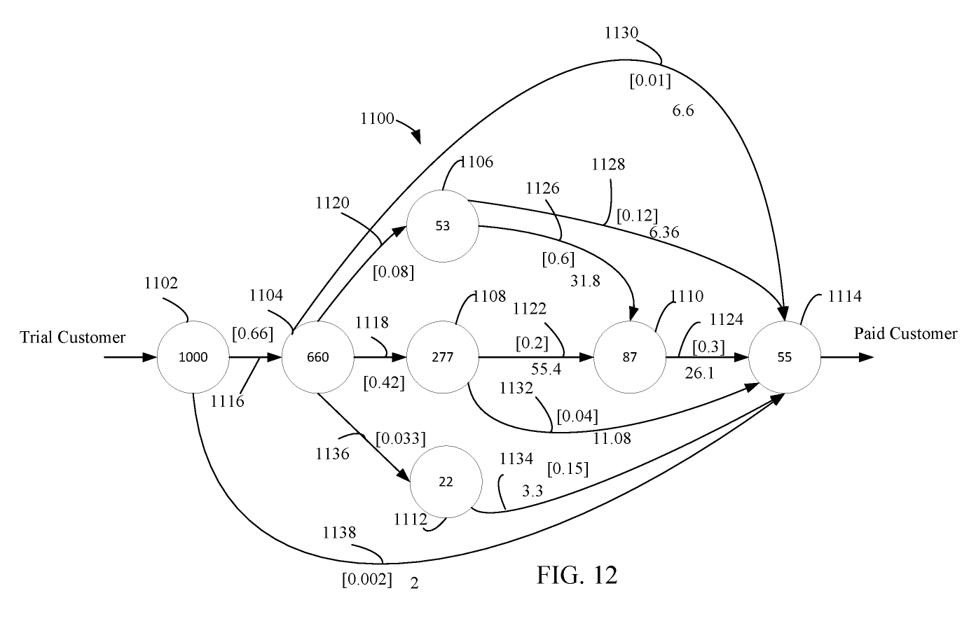

As described above (e.g., with respect to step 206 of FIG. 2), stimulus-enhanced push campaign generator 300 may determine a second set of probabilities for the edges based on a second data set that incorporates stimulus messaging. Node selector 308 may use the second set of probabilities to determine which nodes to assign as stimulus nodes for receiving stimulus messages during a push campaign. For instance, FIG. 12 shows a block diagram of CCJ graph 1100 including a second set of edge probabilities determined with stimulus messaging, according to an example embodiment. As shown in FIG. 12, graph 1100 still includes nodes 1102-1114 and edges 1116-1138, but the edge probabilities and thus weights at affected nodes have changed based on the stimulus message. For instance, node 1102 still has a weight of 1,000 indicating 1,000 users at node 1102 and two outgoing edges 1116 to node 1104 and edge 1138 to node 1114 but the edge probabilities are updated, described in detail as follows. As compared to FIG. 11, the applied stimulus message at node 1102 to entice users to transition to node 1104 increased the edge probability of edge 1116 to 0.66, which increased following nodes and impacted the weight of node 1114.

For instance, as shown in FIG. 12, the edge probability of edge 1116 from node 1102 to node 1104 is 0.66 (66%) and thus, the weight of node 1104 is 660 or 66% of 1,000. Following the above example, there is now a (with stimulus message) 66% chance that a trial user of Microsoft Office® will open or log into Microsoft Office®. Furthermore, and as shown in FIG. 12, the edge probability of edge 1138 from node 1102 to node 1114 remains at 0.002 (0.2%). Thus, there is still a 0.2% chance (resulting in 2 users contributing to the weight of node 1114) that a trial user will become a paid customer.

Focusing now on node 1104, and as shown in FIG. 12, the edge probability of edge 1130 from node 1104 to node 1114 remains at 0.01 (10%). Thus, there is still a 10% chance that a trial user will become a paid customer after logging into Office®, but the number of users contributing to the weight of node 1114 increased to 6.6 due to the increased users at node 1104 based on the stimulus message. As further show in FIG. 12, the edge probability of edge 1120 from node 1104 to node 1106 remains at 0.08 (8%), the edge probability of edge 1118 from node 1104 to node 1108 remains at 0.42 (42%), and the edge probability of edge 1136 from node 1104 to node 1112 remains at 0.033 (3.3%). However, due to the increased weight of node 1104, the users contributing to nodes 1106, 1108 and 1112 are increased to 53, 277, and 22, respectively. Accordingly, and following the example above, there is an 8% chance a trial user will save a document on One Drive® after logging into Office®, there is a 42% chance a trial user will save a document on Office® after logging into Office®, and there is a 3.3% chance a trial user will use Office® on both a mobile and desktop computing device after logging into Office®.

Focusing now on node 1106, and as shown in FIG. 12, the edge probabilities of edge 1128 from node 1106 to node 1114 and edge 1126 from node 1106 to node 1110 remain at 0.12 (12%) and 0.6 (60%). However, due to the increased weights at nodes 1104 and 1106, there are now 31.8 users contributing to the weight of node 1110, indicating that 31.8 trial users will share a document after saving a document. Furthermore, there are now 6.36 users contributing to the weight of node 1114, indicating that 6.36 trial users will become a paid customer after saving a document.

Focusing now on node 1112, and as shown in FIG. 12, the edge probability of edge 1134 from node 1112 to node 1114 remains at 0.15 (15%). Thus, due to the increased weight of node 1104 and node 1112, there are 3 trial users contributing to the weight of node 1114, indicating that 3 trial users will become a paid customer after using Office® on both a mobile and desktop computing device.

Focusing now on node 1108, and as shown in FIG. 12, the edge probability of edge 1132 from node 1108 to node 1114 remains 0.04 (4%). However, due to the increased weight of nodes 1104 and 1108, with a 4% chance that a trial user will become a paid customer after saving a document, 11 trial users contribute to the weight of node 1114. Furthermore, the edge probability of edge 1122 from node 1108 to 1110 remains at 0.2 (20%). Thus, in an example and from node 1108, 55.4 trial users contribute to the weight of node 1110, indicating that 55.4 trial users will share a document after saving a document.

Focusing now on node 1110, and as shown in FIG. 12, the edge probability of edge 1124 from node 1110 to node 1114 remains at 0.3 (30%). Accordingly, 26 trial users contribute to the weight of node 1114, indicating that 26 trial users will become a paid customer after saving a document. Accordingly, and as shown in FIG. 12, with a stimulus message enticing users to transition from node 1102 to node 1104, the number of paid customers increases to 55 customers.

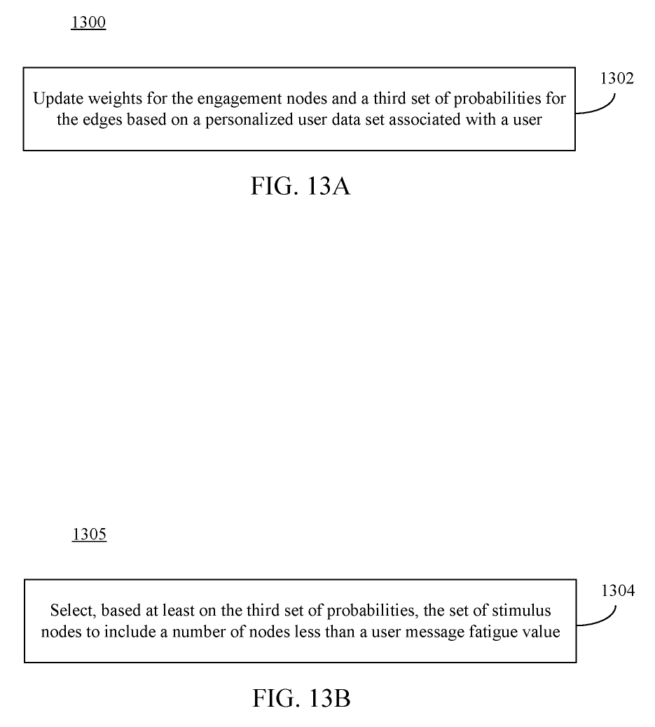

Note that in an embodiment, a CCJ graph may be constructed specific to a user and may determine the set of stimulus nodes specific to a user. For example, FIGS. 13A-13B show flowcharts 1300 and 1305 for constructing a push campaign with personalized stimulus messaging, according to an example embodiment. In an embodiment, flowcharts 1300 and 1305 may be implemented by stimulus-enhanced push campaign generator 104 and flowchart 1305 may be performed as part of step 208 of flowchart 200. Flowcharts 1300 and 1305 are described as follows.

Flowchart 1300 of FIG. 13A begins with step 1302. In step 1302, weights for the engagement nodes and a third set of probabilities for the edges are updated based on a personalized user data set associated with a user. For instance, and with reference to FIG. 3, CCJ optimizer 306 is configured to receive a third data set. Similar to first data set 114 and second data set 314, the third data set is a set of data collected from a single user for various products, indicating how the user performs actions with respect to the products and in what sequence of states the user transitioned through in performing the actions. For example, the third data set may indicate whether or not the user makes a purchase in response to receiving a stimulus message at a node. Based on the third data set, CCJ optimized determines a third set of probabilities for the edges of baseline CCJ graph 312.

Flowchart 1305 of FIG. 13B begins with step 1304. In step 1304, the set of stimulus nodes are selected, based at least on the third set of probabilities, to include a number of nodes less than a user message fatigue value. For instance, and with reference to FIG. 3, node selector 308 is configured to select the stimulus nodes from CCJ graph 116 based at least on the third set of probabilities and to have a number less than a user message fatigue value. A user message fatigue value is the limit of messages that the user received and then never purchased a product. For example, if the user never makes a purchase after three stimulus messages are received, then the user message fatigue value is three.

III. Example Computer System Implementation

Computing device 102, stimulus-enhanced push campaign generator 104, push campaign engine 106, computing device 108, CCJ graph constructor 302, CCJ coefficient generator 304, CCJ optimizer 306, node selector 308, engagement state identifier 402, action identifier 404, weight determiner 702, probability determiner 704, flowchart 200, flowchart 500, flowchart 600, flowchart 800, flowchart 900, flowchart 1000, flowchart 1300, and flowchart 1305 may be implemented in hardware, or hardware combined with one or both of software and/or firmware. For example, stimulus-enhanced push campaign generator 104, push campaign engine 106, CCJ graph constructor 302, CCJ coefficient generator 304, CCJ optimizer 306, node selector 308, engagement state identifier 402, action identifier 404, weight determiner 702, probability determiner 704, flowchart 200, flowchart 500, flowchart 600, flowchart 800, flowchart 900, flowchart 1000, flowchart 1300, and/or flowchart 1305 may be implemented as computer program code/instructions configured to be executed in one or more processors and stored in a computer readable storage medium. Alternatively, stimulus-enhanced push campaign generator 104, push campaign engine 106, CCJ graph constructor 302, CCJ coefficient generator 304, CCJ optimizer 306, node selector 308, engagement state identifier 402, action identifier 404, weight determiner 702, probability determiner 704, flowchart 200, flowchart 500, flowchart 600, flowchart 800, flowchart 900, flowchart 1000, flowchart 1300, and/or flowchart 1305 may be implemented as hardware logic/electrical circuitry.

For instance, in an embodiment, one or more, in any combination, of stimulus-enhanced push campaign generator 104, push campaign engine 106, CCJ graph constructor 302, CCJ coefficient generator 304, CCJ optimizer 306, node selector 308, engagement state identifier 402, action identifier 404, weight determiner 702, probability determiner 704, flowchart 200, flowchart 500, flowchart 600, flowchart 800, flowchart 900, flowchart 1000, flowchart 1300, and/or flowchart 1305 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

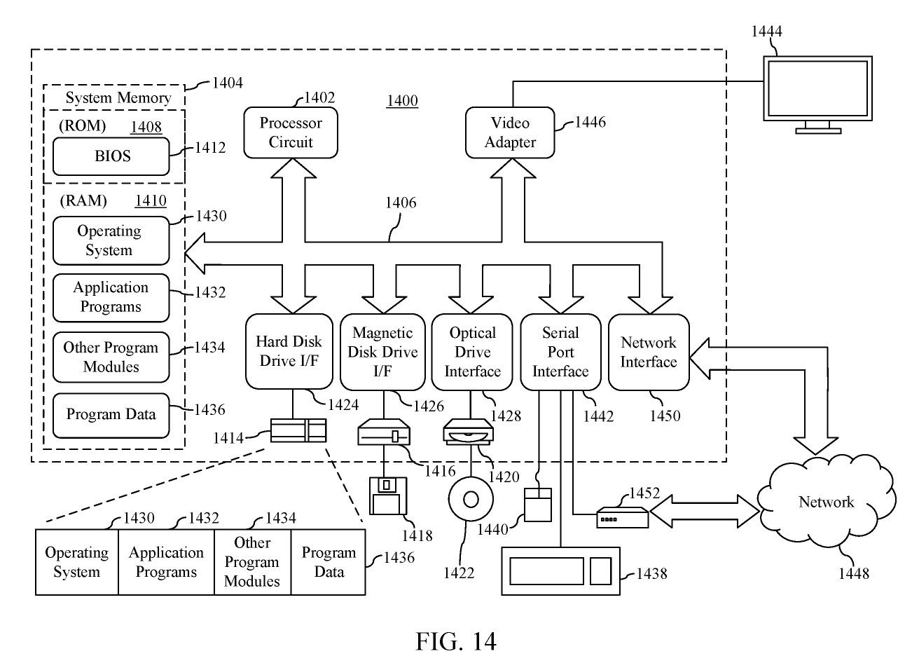

FIG. 14 depicts an exemplary implementation of a computing device 1400 in which embodiments may be implemented. For example, computing device 102 and computing device 108 may each be implemented in one or more computing devices similar to computing device 1400 in stationary or mobile computer embodiments, including one or more features of computing device 1400 and/or alternative features. The description of computing device 1400 provided herein is provided for purposes of illustration, and is not intended to be limiting. Embodiments may be implemented in further types of computer systems, as would be known to persons skilled in the relevant art(s).

As shown in FIG. 14, computing device 1400 includes one or more processors, referred to as processor circuit 1402, a system memory 1404, and a bus 1406 that couples various system components including system memory 1404 to processor circuit 1402. Processor circuit 1402 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1402 may execute program code stored in a computer readable medium, such as program code of operating system 1430, application programs 1432, other programs 1434, etc. Bus 1406 represents one or more of any of several types of bus structures, including a memory bus or memory controller, a peripheral bus, an accelerated graphics port, and a processor or local bus using any of a variety of bus architectures. System memory 1404 includes read only memory (ROM) 1408 and random-access memory (RAM) 1410. A basic input/output system 1412 (BIOS) is stored in ROM 1408.

Computing device 1400 also has one or more of the following drives: a hard disk drive 1414 for reading from and writing to a hard disk, a magnetic disk drive 1416 for reading from or writing to a removable magnetic disk 1418, and an optical disk drive 1420 for reading from or writing to a removable optical disk 1422 such as a CD ROM, DVD ROM, or other optical media. Hard disk drive 1414, magnetic disk drive 1416, and optical disk drive 1420 are connected to bus 1406 by a hard disk drive interface 1424, a magnetic disk drive interface 1426, and an optical drive interface 1428, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1430, one or more application programs 1432, other programs 1434, and program data 1436. Application programs 1432 or other programs 1434 may include, for example, computer program logic (e.g., computer program code or instructions) for implementing stimulus-enhanced push campaign generator 104, push campaign engine 106, CCJ graph constructor 302, CCJ coefficient generator 304, CCJ optimizer 306, node selector 308, engagement state identifier 402, action identifier 404, weight determiner 702, probability determiner 704, flowchart 200, flowchart 500, flowchart 600, flowchart 800, flowchart 900, flowchart 1000, flowchart 1300, and/or flowchart 1305 (or any one or more steps of flowcharts 200, 500, 600, 800, 900, 1000, 1300, and 1305), and/or further embodiments described herein.

A user may enter commands and information into computing device 1400 through input devices such as keyboard 1438 and pointing device 1440. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1402 through a serial port interface 1442 that is coupled to bus 1406, but may be connected by other interfaces, such as a parallel port, game port, or a universal serial bus (USB).

A display screen 1444 is also connected to bus 1406 via an interface, such as a video adapter 1446. Display screen 1444 may be external to, or incorporated in computing device 1400. Display screen 1444 may display information, as well as being a user interface for receiving user commands and/or other information (e.g., by touch, finger gestures, virtual keyboard, etc.). In addition to display screen 1444, computing device 1400 may include other peripheral output devices (not shown) such as speakers and printers.

Computing device 1400 is connected to a network 1448 (e.g., the Internet) through an adaptor or network interface 1450, a modem 1452, or other means for establishing communications over the network. Modem 1452, which may be internal or external, may be connected to bus 1406 via serial port interface 1442, as shown in FIG. 14, or may be connected to bus 1406 using another interface type, including a parallel interface.

As used herein, the terms “computer program medium,” “computer-readable medium,” and “computer-readable storage medium” are used to refer to physical hardware media such as the hard disk associated with hard disk drive 1414, removable magnetic disk 1418, removable optical disk 1422, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1432 and other programs 1434) may be stored on the hard disk, magnetic disk, optical disk, ROM, RAM, or other hardware storage medium. Such computer programs may also be received via network interface 1450, serial port interface 1442, or any other interface type. Such computer programs, when executed or loaded by an application, enable computing device 1400 to implement features of embodiments discussed herein. Accordingly, such computer programs represent controllers of the computing device 1400.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

IV. Additional Example Embodiments

A system is described herein. The system includes: a consumer conversion journey (CCJ) graph constructor configured to construct a graph containing nodes and edges connecting the nodes, the graph representing consumer journey paths for users of a product to transition from an entry state indicated as an entry node of the graph, through a plurality of engagement states indicated as engagement nodes of the graph, to an objective state indicated as an objective node of the graph; a CCJ coefficient generator configured to determine weights for the engagement nodes and a first set of probabilities for the edges based on a first data set obtained without stimulus messaging, each probability of the first set indicating a probability of users transitioning a corresponding edge of the graph; a CCJ optimizer configured to determine a second set of probabilities for the edges based on a second data set that included stimulus messaging; and a node selector configured to select, based at least on the second set of probabilities, a set of stimulus nodes of the graph for sending stimulus messages to users.

In one embodiment of the foregoing system, the CCJ graph constructor comprises:

an engagement state identifier configured to identify the plurality of engagement states to assign as the engagement nodes of the graph between the entry node and the objective node, and an action identifier configured to identify a plurality of actions to assign as the edges connecting nodes in the graph, each action performable by the user to transition from a first node to a second node connected by the assigned edge.

In another embodiment of the foregoing system, the CCJ coefficient generator comprises: a weight determiner configured to determine weights for the engagement nodes based on the first data set, and a probability determiner configured to determine, based on the first data set, the first set of probabilities.

In another embodiment of the foregoing system, the CCJ optimizer is configured to: receive a message number indication that indicates a number of stimulus messages to send to each user of a user set during a first iteration of a test push campaign; execute the first iteration of the test push campaign on the user set to generate the second data set; and determine the second set of probabilities based on the second data set.

In another embodiment of the foregoing system, the node selector is configured to select, based at least on the second set of probabilities, the set of stimulus nodes to include a number of nodes equal to the message number indication.

In another embodiment of the foregoing system, the CCJ graph constructor is configured to: trim nodes from the engagement nodes that correspond to engagement states transitioned to by less than a first threshold percentage of users; and trim edges from the graph that correspond to actions performed by less than a second threshold percentage of users.

In another embodiment of the foregoing system, the system further comprises a push campaign engine configured to perform a push campaign on users of the product by at least sending stimulus messages to consumers that transition to the stimulus nodes of the graph.

In another embodiment of the foregoing system, the node selector is configured to select the set of stimulus nodes to optimize for a maximum number of users to transition from the entry state to the objective state of the graph.

A method is described herein. The method includes constructing a graph containing nodes and edges connecting the nodes, the graph representing consumer journey paths for users of a product to transition from an entry state indicated as an entry node of the graph, through a plurality of engagement states indicated as engagement nodes of the graph, to an objective state indicated as an objective node of the graph; determining weights for the engagement nodes and a first set of probabilities for the edges based on a first data set obtained without stimulus messaging, each probability of the first set indicating a probability of users transitioning a corresponding edge of the graph; determining a second set of probabilities for the edges based on a second data set that included stimulus messaging; and selecting, based at least on the second set of probabilities, a set of stimulus nodes of the graph for sending stimulus messages to users.

In one embodiment of the foregoing method, said constructing the graph containing nodes and edges connecting the nodes comprises: identifying the plurality of engagement states to assign as the engagement nodes of the graph between the entry node and the objective node; and identifying a plurality of actions to assign as the edges connecting nodes in the graph, each action performable by the user to transition from a first node to a second node connected by the assigned edge.

In another embodiment of the foregoing method, said determining the second set of probabilities for the edges based on the second data set that included stimulus messaging comprises: receiving a message number indication that indicates a number of stimulus messages to send to each user of a user set during a first iteration of a test push campaign; executing the first iteration of the test push campaign on the user set to generate the second data set; and determining the second set of probabilities based on the second data set.

In another embodiment of foregoing method, said selecting, based at least on the second set of probabilities, the set of stimulus nodes of the graph for sending stimulus messages to users comprises: selecting, based at least on the second set of probabilities, the set of stimulus nodes to include a number of nodes equal to the message number indication.

In another embodiment of the foregoing method, said constructing the graph containing nodes and edges connecting the nodes comprises: trimming nodes from the engagement nodes that correspond to engagement states transitioned to by less than a first threshold percentage of users; and trimming edges from the graph that correspond to actions performed by less than a second threshold percentage of users.

In another embodiment of the foregoing method, the method further comprises: performing a push campaign on users of the product by at least sending stimulus messages to users that transition to the stimulus nodes of the graph.

In another embodiment of the foregoing method, the method further comprises updating weights for the engagement nodes and a third set of probabilities for the edges based on a personalized user data set associated with a user, each probability of the personalized user data set indicating a probability of the user transitioning to a corresponding edge of the graph, wherein said selecting, based at least on the second set of probabilities, the set of stimulus nodes of the graph for sending stimulus message to users comprises: selecting, based at least on the second set of probabilities, the set of stimulus nodes to include a number of nodes less than a user message fatigue value, the user message fatigue value indicating a limit of messages that should be sent to the user.

A computer-readable medium having computer program logic recorded thereon that when executed by at least one processor causes the at least one processor to perform a method, the method comprises: constructing a graph containing nodes and edges connecting the nodes, the graph representing consumer journey paths for users of a product to transition from an entry state indicated as an entry node of the graph, through a plurality of engagement states indicated as engagement nodes of the graph, to an objective state indicated as an objective node of the graph; determining weights for the engagement nodes and a first set of probabilities for the edges based on a first data set obtained without stimulus messaging, each probability of the first set indicating a probability of users transitioning a corresponding edge of the graph; determining a second set of probabilities for the edges based on a second data set that included stimulus messaging; and selecting, based at least on the second set of probabilities, a set of stimulus nodes of the graph for sending stimulus messages to users.

In one embodiment of the foregoing computer-readable medium, said constructing the graph containing nodes and edges connecting the nodes comprises: identifying the plurality of engagement states to assign as the engagement nodes of the graph between the entry node and the objective node; and identifying a plurality of actions to assign as the edges connecting nodes in the graph, each action performable by the user to transition from a first node to a second node connected by the assigned edge.

In another embodiment of the foregoing computer-readable medium, said determining the second set of probabilities for the edges based on the second data set that included a message stimulus comprises: receiving a message number indication that indicates a number of stimulus messages to send to each user of a user set during a first iteration of a test push campaign; executing the first iteration of the test push campaign on the user set to generate the second data set; and determining the second set of probabilities based on the second data set.

In another embodiment of the foregoing computer-readable medium, said selecting, based at least on the second set of probabilities, the set of stimulus nodes of the graph for sending stimulus messages to users comprises: selecting, based at least on the second set of probabilities, the set of stimulus nodes to include a number of nodes equal to the message number indication.

In another embodiment of the foregoing computer-readable medium, said constructing the graph containing nodes and edges connecting the nodes comprises: trimming nodes from the engagement nodes that correspond to engagement states transitioned to by less than a first threshold percentage of users; and trimming edges from the graph that correspond to actions performed by less than a second threshold percentage of users.

In another embodiment of the foregoing computer-readable medium, the method further comprises: performing a push campaign on users of the product by at least sending stimulus messages to users that transition to the stimulus nodes of the graph.

V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A system, comprising:
a consumer conversion journey (CCJ) graph constructor configured to construct a graph containing nodes and edges connecting the nodes, the graph representing consumer journey paths for users of a product to transition from an entry state indicated as an entry node of the graph, through a plurality of engagement states indicated as engagement nodes of the graph, to an objective state indicated as an objective node of the graph;
a CCJ coefficient generator configured to determine weights for the engagement nodes and a first set of probabilities for the edges based on a first data set obtained without stimulus messaging, each probability of the first set indicating a probability of users transitioning a corresponding edge of the graph;
a CCJ optimizer configured to determine a second set of probabilities for the edges based on a second data set that included stimulus messaging; and
a node selector configured to select, based at least on the second set of probabilities, a set of stimulus nodes of the graph for sending stimulus messages to users.

2. The system of claim 1, wherein the CCJ graph constructor comprises:
an engagement state identifier configured to identify the plurality of engagement states to assign as the engagement nodes of the graph between the entry node and the objective node, and
an action identifier configured to identify a plurality of actions to assign as the edges connecting nodes in the graph, each action performable by the user to transition from a first node to a second node connected by the assigned edge.

3. The system of claim 1, wherein the CCJ coefficient generator comprises:
a weight determiner configured to determine weights for the engagement nodes based on the first data set, and
a probability determiner configured to determine, based on the first data set, the first set of probabilities.

4. The system of claim 1, wherein the CCJ optimizer is configured to:
receive a message number indication that indicates a number of stimulus messages to send to each user of a user set during a first iteration of a test push campaign;
execute the first iteration of the test push campaign on the user set to generate the second data set; and
determine the second set of probabilities based on the second data set.

5. The system of claim 4, wherein the node selector is configured to select, based at least on the second set of probabilities, the set of stimulus nodes to include a number of nodes equal to the message number indication.

6. The system of claim 1, wherein the CCJ graph constructor is configured to:
trim nodes from the engagement nodes that correspond to engagement states transitioned to by less than a first threshold percentage of users; and
trim edges from the graph that correspond to actions performed by less than a second threshold percentage of users.

7. The system of claim 1, further comprising:
a push campaign engine configured to perform a push campaign on users of the product by at least sending stimulus messages to consumers that transition to the stimulus nodes of the graph.

8. The system of claim 1, wherein the node selector is configured to select the set of stimulus nodes to optimize for a maximum number of users to transition from the entry state to the objective state of the graph.

9. A method, comprising:
constructing a graph containing nodes and edges connecting the nodes, the graph representing consumer journey paths for users of a product to transition from an entry state indicated as an entry node of the graph, through a plurality of engagement states indicated as engagement nodes of the graph, to an objective state indicated as an objective node of the graph;
determining weights for the engagement nodes and a first set of probabilities for the edges based on a first data set obtained without stimulus messaging, each probability of the first set indicating a probability of users transitioning a corresponding edge of the graph;
determining a second set of probabilities for the edges based on a second data set that included stimulus messaging; and
selecting, based at least on the second set of probabilities, a set of stimulus nodes of the graph for sending stimulus messages to users.

10. The method of claim 9, wherein said constructing the graph containing nodes and edges connecting the nodes comprises:
identifying the plurality of engagement states to assign as the engagement nodes of the graph between the entry node and the objective node; and
identifying a plurality of actions to assign as the edges connecting nodes in the graph, each action performable by the user to transition from a first node to a second node connected by the assigned edge.

11. The method of claim 9, wherein said determining the second set of probabilities for the edges based on the second data set that included stimulus messaging comprises:
receiving a message number indication that indicates a number of stimulus messages to send to each user of a user set during a first iteration of a test push campaign;
executing the first iteration of the test push campaign on the user set to generate the second data set; and
determining the second set of probabilities based on the second data set.

12. The method of claim 9, wherein said constructing the graph containing nodes and edges connecting the nodes comprises:
trimming nodes from the engagement nodes that correspond to engagement states transitioned to by less than a first threshold percentage of users; and
trimming edges from the graph that correspond to actions performed by less than a second threshold percentage of users.

13. The method of claim 9, further comprising:
performing a push campaign on users of the product by at least sending stimulus messages to users that transition to the stimulus nodes of the graph.

14. The method of claim 9, further comprising:
updating weights for the engagement nodes and a third set of probabilities for the edges based on a personalized user data set associated with a user, each probability of the personalized user data set indicating a probability of the user transitioning to a corresponding edge of the graph,
wherein said selecting, based at least on the second set of probabilities, the set of stimulus nodes of the graph for sending stimulus message to users comprises:
selecting, based at least on the second set of probabilities, the set of stimulus nodes to include a number of nodes less than a user message fatigue value, the user message fatigue value indicating a limit of messages that should be sent to the user.

15. A computer-readable medium having computer program logic recorded thereon that when executed by at least one processor causes the at least one processor to perform a method, the method comprising:
constructing a graph containing nodes and edges connecting the nodes, the graph representing consumer journey paths for users of a product to transition from an entry state indicated as an entry node of the graph, through a plurality of engagement states indicated as engagement nodes of the graph, to an objective state indicated as an objective node of the graph;
determining weights for the engagement nodes and a first set of probabilities for the edges based on a first data set obtained without stimulus messaging, each probability of the first set indicating a probability of users transitioning a corresponding edge of the graph;
determining a second set of probabilities for the edges based on a second data set that included stimulus messaging; and
selecting, based at least on the second set of probabilities, a set of stimulus nodes of the graph for sending stimulus messages to users.

16. The computer-readable medium of claim 15, wherein said constructing the graph containing nodes and edges connecting the nodes comprises:
identifying the plurality of engagement states to assign as the engagement nodes of the graph between the entry node and the objective node; and
identifying a plurality of actions to assign as the edges connecting nodes in the graph, each action performable by the user to transition from a first node to a second node connected by the assigned edge.

17. The computer-readable medium of claim 15, wherein said determining the second set of probabilities for the edges based on the second data set that included a message stimulus comprises:
receiving a message number indication that indicates a number of stimulus messages to send to each user of a user set during a first iteration of a test push campaign;
executing the first iteration of the test push campaign on the user set to generate the second data set; and
determining the second set of probabilities based on the second data set.

18. The computer-readable medium of claim 17, wherein said selecting, based at least on the second set of probabilities, the set of stimulus nodes of the graph for sending stimulus messages to users comprises:
selecting, based at least on the second set of probabilities, the set of stimulus nodes to include a number of nodes equal to the message number indication.

19. The computer-readable medium of claim 15, wherein said constructing the graph containing nodes and edges connecting the nodes comprises:
trimming nodes from the engagement nodes that correspond to engagement states transitioned to by less than a first threshold percentage of users; and
trimming edges from the graph that correspond to actions performed by less than a second threshold percentage of users.

20. The computer-readable medium of claim 15, wherein the method further comprises:
performing a push campaign on users of the product by at least sending stimulus messages to users that transition to the stimulus nodes of the graph.
